(19) United States
(12) Patent Application Publication
(10) Pub. No.: US 2010/0162357 A1
(43) Pub. Date: Jun. 24, 2010

(54) IMAGE-BASED HUMAN INTERACTIVE PROOFS

(75) Inventors: David M. Chickering, Bellevue, WA (US); Kristofer N. Iverson, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/339,402

(22) Filed: Dec. 19, 2008

(51) Int. Cl. G06K 9/00; G06K 9/68

(52) U.S. Cl. 726/3; 382/218

(57) ABSTRACT

This document describes image-based human interactive proofs (HIPs). In some cases these proofs may be used when a browser at a client is used to access resources from a web server. Before access to the resources is enabled, the client can be challenged by the web server with an image-based puzzle. The image-based puzzle is configured to enable distinctions to be made between human input and non-human input. Input to answer the image-based puzzle can be formed via the client and communicated to the web server. The web server receives the input from the client and selectively enables client access to the resources based upon the input. In at least some embodiments, the web server can make use of a community database that stores client answers to image-based puzzles to assist in distinguishing between human input and non-human input.

### BACKGROUND

Through the Internet, web providers have made many types of web-based resources freely available to users, such as e-mail accounts, search services, and instant messaging. Unfortunately, malicious entities may take advantage of freely available resources to use them for illegitimate and undesirable purposes, such as spamming, web attacks, and virus distribution. To frustrate the efforts of these malicious entities, Human Interactive Proofs (HIPs) have been employed to selectively provide access to resource when the HIP determines that a given interaction came from a person. Doing so creates barriers to malicious entities that make use of automated systems to abuse or overuse freely available resources.

One traditional technique for a human interactive proof involves presenting a text-based puzzle. This technique involves challenging a computing device (e.g., a client) with a text-based puzzle when the computing device attempts to access resources. Typically, the answer to the puzzle is text within the puzzle that has been obfuscated in some manner to make it difficult for a computer to recognize. Recently, improvements in optical character recognition (OCR) have all but defeated the viability of the traditional text-based puzzles for HIP. Accordingly, some traditional HIP techniques may no longer be capable of creating a successful barrier to malicious entities.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

This document describes image-based human interactive proofs (HIPs). In some cases these proofs may be used when a browser at a client is used to access resources from a web server. Before access to the resources is enabled, the client can be challenged by the web server with an image-based puzzle. The image-based puzzle is configured to enable distinctions to be made between input from humans and non-human input (e.g., automated computer input). Input to answer the image-based puzzle can be formed via the client and communicated to the web server. The web server receives the input from the client and selectively enables client access to the resources based upon the input. In at least some embodiments, the web server can make use of a community database that stores client answers to image-based puzzles to assist in distinguishing between human input and non-human input.

### BRIEF DESCRIPTION OF THE DRAWINGS

The same numbers are used throughout the drawings to reference like features.

FIG. 1 illustrates an operating environment in accordance with one or more embodiments.

FIG. 2 is a flow diagram that describes acts in a method in accordance with one or more embodiments.

FIG. 3 is a flow diagram that describes act in a method in accordance with one or more embodiments.

FIG. 4 illustrates a diagram of an example user interface in accordance with one or more embodiments.

FIG. 5 illustrates a diagram of an example user interface in accordance with one or more embodiments.

FIG. 6 illustrates a diagram of an example user interface portion in accordance with one or more embodiments.

FIG. 7 illustrates example image-based puzzles in accordance with one or more embodiments.

### DETAILED DESCRIPTION

### Overview

This document describes image-based human interactive proofs (HIPs). In some cases these proofs are used when a browser at a client is employed to navigate to a web server to access resources. Before permitting access to the resources, the web server can challenge the client with an image-based puzzle.

Traditional “text-based” puzzles consist of images that contain obfuscated text. In order to solve these puzzles, users must prove that they can recognize the obfuscated text (e.g., by typing in the text). Due to advances in optical-character recognition technology, these puzzles are increasingly easier to solve automatically.

Rather than using traditional text-based puzzles, the techniques described herein employ image-based puzzles that make use of non-text graphical images. Some image-based puzzles are configured to ask for input of a description to describe one or more graphical images presented in the puzzle. For example, an image-based puzzle may request input to describe something that is missing from an image of the puzzle, ask for a description of a commonality between multiple images presented in the puzzle, or provide one or more descriptions and request that these descriptions be matched to corresponding images in the puzzle.

These example image-based puzzles are crafted to rely upon capabilities and creativity that humans possess and computers lack, which makes it difficult for a computer to derive a valid answer to the puzzles. Accordingly, image-based puzzles enable distinctions to be made between input from humans and input from computers (e.g., non-human input). More particularly, a web server can use answers given in response to image-based puzzles as proof of a human's interaction.

To perform these image-based human interactive proofs, the web server obtains answers in response to presentation of image-based puzzles to clients. For instance, input in response to a puzzle can be formed via a client and communicated to the web server as an answer. The web server receives this answer from the client and determines whether the answer came from a person or was non-human input. To do so, the web server can compare the received answer to one or more answers known to be from humans. Based on this comparison, the web server can determine if the answer came from a human or computer and selectively enable client access to resources accordingly. In at least some embodiments, the web server can make use of a community database that stores client answers to image-based puzzles to assist in distinguishing between human input and non-human input.

In the discussion that follows, a section entitled “Operating Environment” describes but one environment in which the embodiments can be employed. After this, a section entitled “Image-Based HIP Examples” is provided that describes embodiments in which images can be employed to distinguish between human input and non-human input. A section entitled “Image-Based Puzzle Examples” follows and describes example user interfaces and image-based puzzles suitable to implement embodiments of image-based HIP described herein.

### Operating Environment

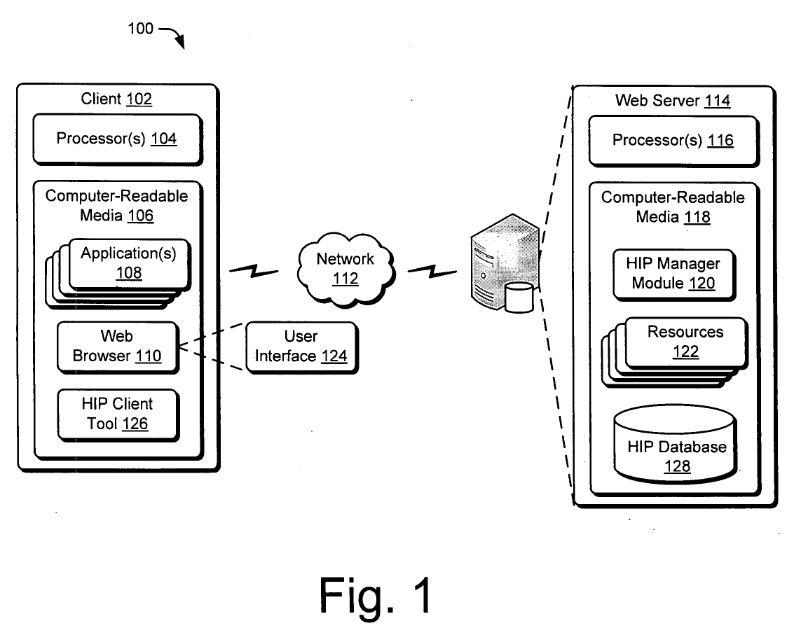

FIG. 1 illustrates an operating environment in accordance with one or more embodiments, generally at 100. Environment 100 includes a client 102 having one or more processors 104, one or more computer-readable media 106, and one or more applications 108 that reside on the computer-readable media 106, and which are executable by the processor(s) 104. Applications 108 can include any suitable type of application such as an operating system, productivity applications, multimedia applications, e-mail applications, instant messaging applications, and a variety of other applications. The client 102 can be embodied as any suitable computing device such as a desktop computer, a portable computer, a handheld computer such as a personal digital assistant (PDA), cell phone, and the like.

Client 102 also includes a web browser 110. The web browser represents functionality available to a user of the computing device 102 to navigate over a network 112, such as the Internet, to one or more web servers 114 from and to which content can be received and sent. The web browser 110 can operate to output a variety of user interfaces through which the user may interact with content that is available from the one or more web servers 114. The web server 114 represents an example of an online server that may be accessible to the client via the Internet, an intranet, or another suitable network. The web server or other suitable online server (e.g., a corporate server, data server, and so forth) may provide an online presence of a service provider through which clients may obtain corresponding content.

The example web server 114 of FIG. 1 includes one or more processors 116 and one or more computer-readable media 118. The computer-readable media 106 and/or 118 can include, by way of example and not limitation, all forms of volatile and non-volatile memory and/or computer storage media that are typically associated with a computing device. Such media can include ROM, RAM, flash memory, optical disks, hard disk, removable media and the like. Aspects of the techniques described herein may be implemented in hardware, software, or otherwise. In a software context, the techniques may be implemented via program modules stored in the computer-readable media 106 and/or 118 and having instructions executable via the processors 104 and/or 116.

The web server 114 can also be configured to enable or otherwise make use of a human interactive proof (HIP) manager module 120 that operates as described herein. The HIP manager module represents a variety of functionality operable to distinguish human-based interaction from non-human interaction, such as automated input from a computer. For example, the HIP manager module may perform human interactive proofs using image-based puzzles and selectively enable client access to a variety of resources 122 based on these image-based human interactive proofs. Some example puzzles and user interfaces are described in a section below titled “Image-Based Puzzle Examples”.

Web server 114 is illustrated as having resources 122. The web server can implement the HIP manager module to selectively provide the resources 122 to clients in accordance with image-based HIP techniques described herein. As used herein, the resources can include services and/or content available to clients via a web server. Some examples of such resources include e-mail service, search service, instant messaging service, shopping service, web-based applications, web pages, multimedia content, television content, and so forth.

When a client attempts to access resources, the HIP manager module can be configured to present an image-based puzzle to challenge the client. The image-based puzzle can be communicated over the network for execution by the client. For instance, a web browser of a client can receive an image-based puzzle communicated from the web server. The web browser can output a user interface at the client that incorporates the image-based puzzle, such as the example user interface 124 depicted in FIG. 1.

In one embodiment, a client can implement or make use of an HIP client tool 126 as depicted in FIG. 1. The HIP client tool may represent client-side functionality operable to implement aspects of image-based HIP techniques described herein. For instance, the HIP client tool can interact with the HIP manager module of a web server to obtain image-based puzzles, cause output of puzzles via the web browser, receive input related to the puzzles, and communicate responses back to the HIP manager module. While illustrated as a stand-alone module, the HIP client tool can also be implemented as a component of the web browser.

The example web server of FIG. 1 also includes an HIP database 128. HIP database 128 represents functionality to store a variety of data related to image-based HIP techniques described herein. For example, HIP database can store images and/or image-based puzzles that may be output to clients via the HIP manager module and/or the HIP client tool. Data maintained by the HIP database can also include answers to image-based puzzles that are received from clients. Further, data in the HIP database can include pre-configured puzzle answers known to be from humans.

The data maintained in the HIP database can assist the HIP manager module in distinguishing between human input and non-human input. The HIP manager module can analyze, combine, or otherwise make use of the data to arrive at one or more answers that are considered valid for a given puzzle. For instance, the HIP manager module can reference the database to compare a puzzle answer from a client to one or more answers known to be from humans and/or to answers to the puzzle that are collected from other clients. By so doing, the HIP manager module uses the HIP database to implement a community-based aspect whereby answers that are valid for a given puzzle can be based at least in part upon answers from a community of users. Further discussion of community-based aspects involved in image-based HIP techniques can be found in relation to the following figures.

Consider an example in which a client attempts to set-up an e-mail account or other user account with a web provider via the web server. Often, malicious entities use automated computer systems to establish numerous accounts with web providers for illegitimate or questionable purposes, such as for E-mail spamming, web-attacks, virus distribution, and so forth. Image-based HIP techniques described herein can be employed to make it more difficult for malicious entities to set-up these accounts. By enabling web providers to distinguish between human input and non-human input, image-based puzzles can act as a barrier that makes it more difficult for “non-legitimate” entities to obtain accounts. While user account set-up is described as an example, image-based HIP techniques can be used in a variety of other settings. Generally, the techniques can be applied wherever resources are made freely available and/or it is desirable to prevent overuse and abuse that can occur through automated access to resources.

Having considered an example operating environment, consider now a discussion of embodiments in which human interactive proofs (HIPs) can be performed using image-based puzzles presented to clients.

### Image-Based HIP Examples

The following discussion describes example image-based HIP techniques that may be implemented utilizing the previously described environment. Aspects of the techniques may be implemented in hardware, software, firmware, or a combination thereof. The techniques are shown as a set of blocks that specify operations performed by one or more entities and are not necessarily limited to the orders shown for performing the operations. In at least some embodiments, the operations can be performed by a suitably configured server-side module, such as the example HIP manager module 120 described above with respect to FIG. 1.

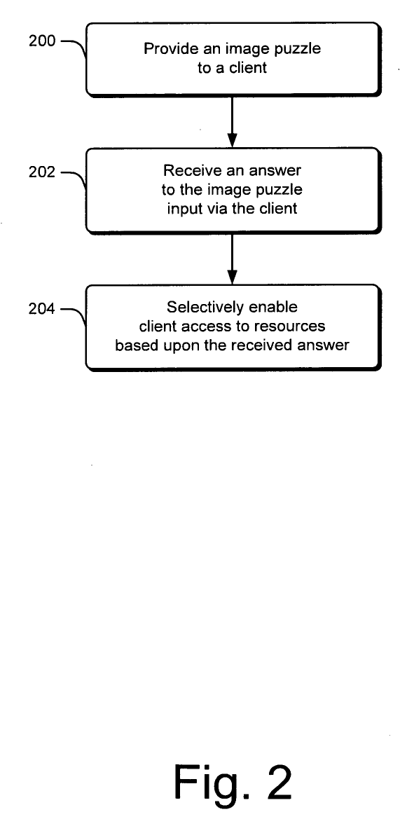

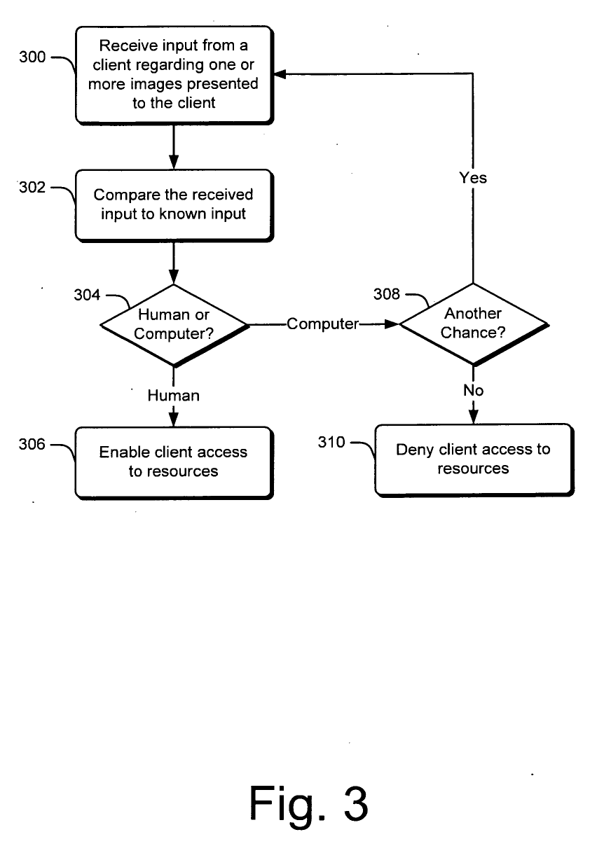

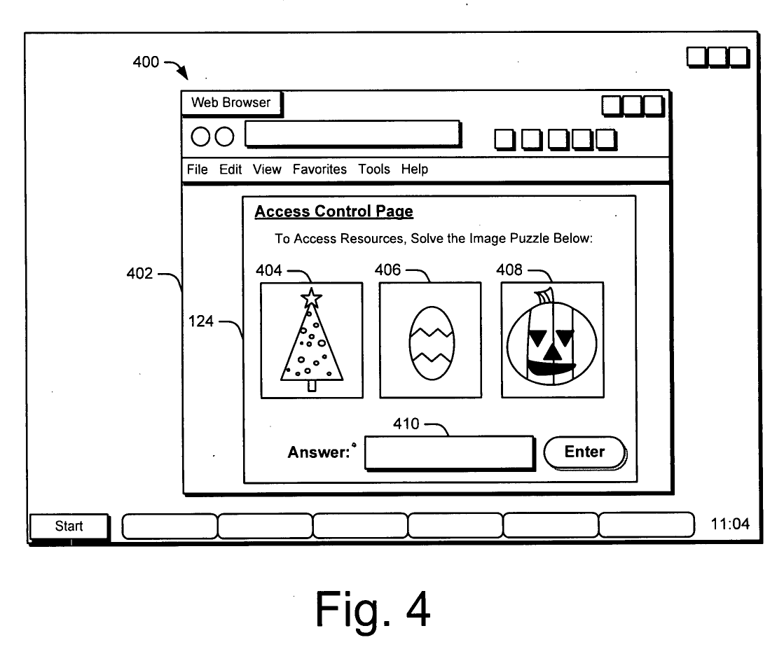

FIG. 2 is a flow diagram that describes acts in a method in accordance with one or more embodiments. FIG. 3 depicts another flow diagram that describes acts in a method in accordance with one or more embodiments. In the discussion of FIG. 2 and FIG. 3 that follows, reference may be made to the example image-based puzzle depicted in FIG. 4.

Consider now the flow diagram depicted in FIG. 2. At block 200 an image-based puzzle is provided to a client. For example, an image-based puzzle as depicted in FIG. 4 can be provided when a web browser of a client attempts to access to resources available from the web server. The example image-based puzzle of FIG. 4 presents multiple images and requests an answer to describe the images. A detailed discussion of this example and other examples of suitable image-based puzzles can be found in a section below entitled “Image-Based Puzzle Examples”.

Providing an image-based puzzle can occur through an access control webpage communicated to a client in response to an attempt to access resources. For example, the HIP manager module can communicate an access control webpage having one or more images that form the image-based puzzle. To do so, the HIP manager module may obtain a pre-configured puzzle and/or webpage from an HIP database or other suitable storage. Additionally or alternatively, the HIP manager module may obtain images for a puzzle from storage and configure the access control webpage with the images at the server. Providing of an image-based puzzle can also include communicating images and/or other data sufficient to enable client-side configuration of the puzzle and/or webpage, such as by way of an HIP client tool.

To make it difficult for an automated computer to describe, match, or otherwise process an image and/or image-based puzzle, the graphical images employed in an image-based puzzle can be complex. Further, deriving a valid answer based on the graphical images may involve innate capabilities and creativity that humans possess and computers lack. Moreover, a valid answer to an image-based puzzle may be based at least in part on answers obtained from a community of users. This may make it even more difficult for a computer to arrive at a valid answer. Accordingly, images for inclusion in an image-based puzzle can be selected to enable the HIP manager module or equivalent functionality to distinguish between human and non-human input.

At block 202 an answer to the image-based puzzle input via the client is received. Consider an example image-based puzzle that requests input of a description to describe one or more images presented in the puzzle, such as the example puzzle of FIG. 4. The image-based puzzle having the one or more graphical images can be obtained at a web server and communicated to a client as just described. In this example, a textual description can be input at the client and communicated back to the web server.

At block 204 client access to resources is selectively enabled based upon the received answer. In the above example, the HIP manager module may receive the textual description that is input via the client as an answer to the image-based puzzle. The HIP manager module can make a determination regarding whether the received answer is human-input or non-human input. Based on this determination, client access to resources can be enabled when the input is human input and denied when the input is non-human input.

Referring now to FIG. 3, a flow diagram is depicted that describes acts in a method in accordance with one or more embodiments. In at least some embodiments, the method can be performed by a suitably configured web server, such as the web server 114 described above in relation to FIG. 1.

At block 300 input from a client is received regarding one or more images presented to the client. For example, a client can provide input as an answer to an image-based puzzle in response to presentation of the puzzle by a web server. The web server can include an HIP manager module to process puzzle answers received from clients. From the perspective of the HIP manager module, answers to puzzles received from clients might be human input or non-human input.

Upon receiving an answer to an image puzzle, the HIP manager module distinguishes between human input and non-human input. At block 302 the received input is compared to one or more known answers to the puzzle. Based on this comparison, block 304 determines whether the received input is human or non-human input. The known answers can be one or more answers that are determined to be valid for a given image-based puzzle. Validity in this context refers to a determination that the answer is input through human interaction rather than through non-human interaction.

To arrive at valid answers for a given puzzle, the HIP manager module can make use of a community database of answers, such as the HIP database of FIG. 1. The community database of answers may include answers collected through test puzzles and/or images presented to humans. This collection can occur in an offline test environment, through online games, and/or other techniques capable of collecting input known to be human. The community database can also include answers from clients given in response to presentation of image-based puzzles. In one embodiment, answers to puzzles can be categorized as being from a human or a computer. These categorizations can be stored along with the answers in the community database to inform future determinations.

Analysis of the community database can reveal answers that are more relevant than others, the most common answers, known human answers, outlying answers, answers likely to be non-human input, and so forth. Based on such analysis, an iterative process can be employed to improve selection of puzzles and corresponding answers that are likely to distinguish between human interaction and automated computer interaction. Through this iterative process, answers to a particular puzzle may change over time to reflect community feedback. Accordingly, the HIP manager module can make use of answers and other data in the community database to make a determination regarding whether a received answer is from a human or a computer.

When the input is determined to be from a human, block 306 enables client access to resources. For example, a client seeking to register for a new e-mail account may be allowed to do so. When the input is determined to be from a computer, block 308 may optionally provide another chance. For instance, a configurable number of chances may be set to give additional chances to solve an image-based puzzle. This can be done to minimize instances in which resources are denied to legitimate users who input an incorrect puzzle answer. When another chance is available, another image-based puzzle may be output to the client and the procedure may return to repeat blocks 300-304 for the other puzzle. When another chance is not available in block 308, block 310 may deny client access to resources. For example, the corresponding client would not be permitted to proceed with establishing a new e-mail account, accessing services, or obtaining other protected resources.

Having described example embodiments in which image-based human interactive proofs can occur, consider now a discussion of example user interfaces and image-based puzzles suitable for use in one or more embodiments of image-based human interactive proofs.

### Image-Based Puzzle Examples

The following portion presents examples of image-based puzzles suitable for use with the described image-based HIP techniques. The examples set forth herein are by no means intended to be limiting, though these examples do provide a glimpse of the wide variety of image-based puzzles that may be crafted to enable human interaction to be separated from automated computer interaction.

FIG. 4 illustrates a diagram of an example user interface in accordance with one or more embodiments, generally at 400. A web browser user interface 402 is depicted as being rendered that incorporates a user interface 124 of FIG. 1. The user interface 124 in this example is configured as an access control page that can be output via the web browser to enable image-based HIP techniques. The user interface 124 or data sufficient to form the user interface can be configured at a web server and communicated over a network to enable rendering by the client. In the illustrated example, the access control page includes a plurality of images that form an image-based puzzle. In particular, a Christmas-tree image 404, an Easter-egg image 406, and a Jack-O'-Lantern image 408 are illustrated. The access control page also includes an answer prompt in the form of the text “To Access Resources, Solve the Image Puzzle Below”. The access control page further includes a selectable portion 410 that is operable to receive input to answer the presented image-based puzzle. Specifically, a textual description regarding the image-based puzzle may be input via the portion 410.

The image-based puzzle of FIG. 4 illustrates how capabilities and creativity that are possessed by humans and not by computers can be relied upon to craft successful image-based puzzles. As in the depicted example, an image-based puzzle can be based on a commonality between multiple images presented in the image-puzzle. The commonality may be selected to be perceptible to humans but imperceptible to computers. In the illustrated example, each of the images relate to a different holiday.

A human may very quickly arrive at a suitable answer to this image-based puzzle. This is so because a person is capable of relating images according to a commonality in a way that can be difficult for a computer that does not have the benefit of human experiences. For this type of puzzle, an answer prompt may be configured to specifically ask for identification of a commonality between the multiple images. A human may identify the commonality of “holidays” and input the answer. However, it may be difficult or impossible for a computer to arrive at this answer. Even if a computer can somehow recognize the images (e.g., through OCR or other techniques), answers related to individual images such as “Christmas”, “egg”, or “Easter” will be incorrect answers. Such incorrect answers can also be detected by the HIP manager module as signals that an automated program is being used. Unlike some traditional text-based puzzles, the image-based puzzle does not contain text or a text representation sufficient to answer the puzzle. Rather, the puzzle makes use of human creativity.

While the images presented in the foregoing example are quite simple, appreciate that adding complexity to the images can make it even more difficult for a computer to arrive at suitable description of the images. To improve the system even further, additional restrictions such as time restrictions, navigation control, and/or focus locks can be used in conjunction with the image-based puzzle to prevent searching, OCR, and other techniques that may be attempted by automated computers that encounter the puzzles.

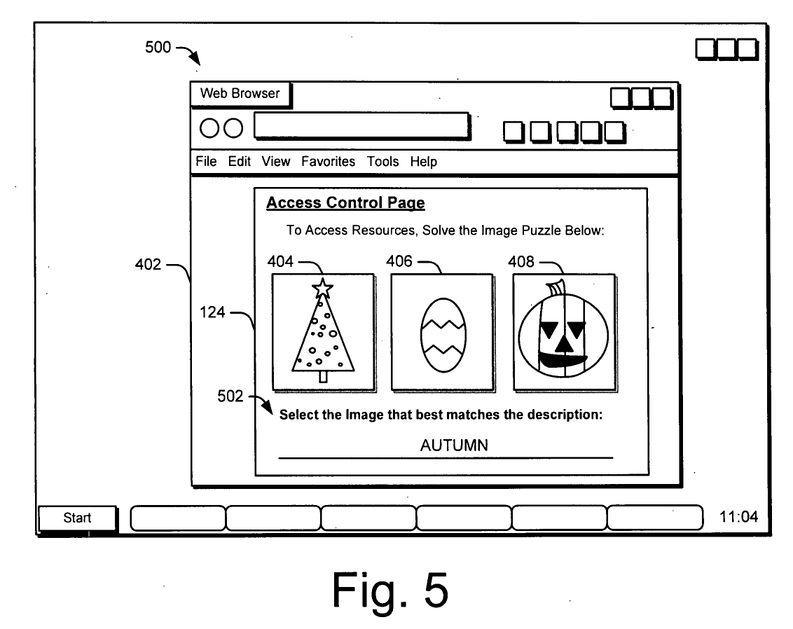

Another example image-based puzzle is illustrated in FIG. 5. FIG. 5 illustrates generally at 500 the web browser user interface 402 having a user interface 124 as in the preceding example. The user interface presents an access control page including the same Christmas-tree image 404, Easter-egg image 406, and Jack-O'-Lantern image 408 that appear in FIG. 4. However, rather than asking for a description of the images as in FIG. 4, the example image-based puzzle of FIG. 5 includes a portion 502 where a description is provided to the user. In particular, the description “Autumn” is presented.

To solve this type of image-based puzzle, the user is asked to match one or more descriptions to one or more corresponding images. Access control page can be configured to enable this matching through techniques including user selection of images, dragging and dropping of descriptions, multiple choice controls, and so forth. In the example of FIG. 5, the images are depicted as being selectable to cause input of a corresponding answer to the puzzle. Specifically, a selection of Jack-O'-Lantern image 408 in FIG. 5 can correctly answer the image-based puzzle.

While the example depicted in FIG. 5 is again relatively simple, note that the complexity of an image-based puzzle can be increased by increasing the number of images and/or the number of descriptions to match to the images. For example, an image-based puzzle can be configured to include twenty-five images and five descriptions to match to the images. In another variation, the image-based puzzle can be configured to request that a user match two or more images to each description. Naturally, other combinations for the number of images and descriptions in an image-based puzzle can also be employed.

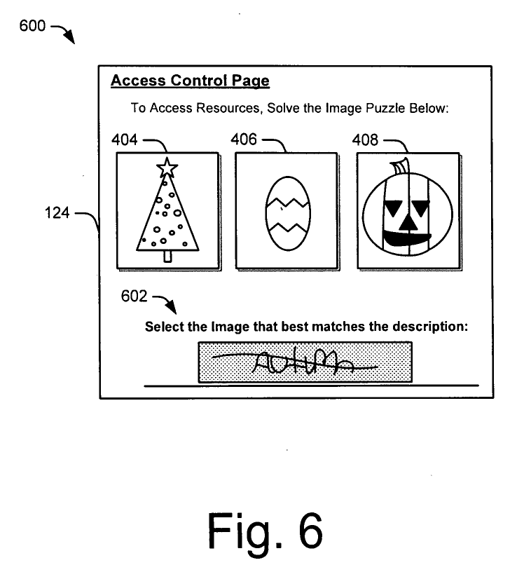

Referring now to FIG. 6, another example image-based puzzle in accordance with one or more embodiments is depicted. FIG. 6 depicts generally at 600 an example access control page of user interface 124 similar to the one that appears in FIG. 5. This example illustrates that an image-based puzzles can make use of some techniques employed in traditional text-based puzzles. In particular, notice that the textual description “Autumn” provided in FIG. 5 has been obfuscated in FIG. 6. However, unlike the traditional text-based puzzles “Autumn” is not the answer to the puzzle itself. Rather, “Autumn” is a descriptive clue that is to be matched to a corresponding image to solve the puzzle.

Textual obfuscation techniques of this kind can be employed to make it more difficult for OCR to be used to understand the clues, prompts, and other supporting text in the image puzzle. When used alone, text-based puzzles employing textual obfuscation may not create sufficient barriers to malicious parties. However, combining textual obfuscation with image-based puzzles can create an additional barrier to malicious parties who make use of automated computer tools to abuse or overuse resources made available by web providers. Text in an image-based puzzle can be obfuscated in any suitable way; some examples including smashing characters together, adding extraneous lines and/or characters, making characters blurry, and so forth.

Note that the images can also be obfuscated. For instance, a variety of obfuscation techniques can be applied to make images blurry, distorted, and less obvious. Doing so can make OCR, image matching, and searching techniques that are easily performed by computers less useful in the context of solving image-based puzzles. At the same time, people are quite adept at recognizing faces, shapes, patterns, and so forth within images. It is almost impossible for the human brain not to make these kinds of associations. People are able to do so even within relatively featureless shapes, such as when children pass time discovering images within the clouds on a whimsical day. Because of these innate human capabilities, images can be heavily obfuscated to frustrate the efforts of automated computers while still enabling humans to effectively respond to image-based puzzles that makes use of the images.

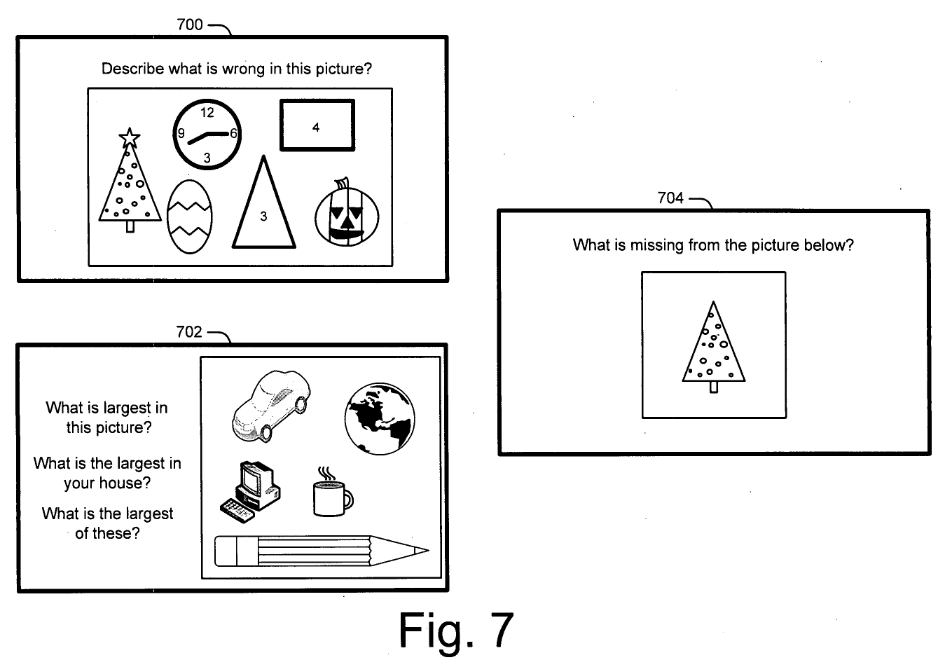

Some additional examples of image-based puzzles suitable for use in the described image-based HIP techniques are depicted in FIG. 7. Image-based puzzle 700 provides a plurality of images and includes a prompt that says “Describe what is wrong with this image:” A brief survey of the image-based puzzle reveals that the “3” and the “6” on the clock have been swapped. Again, the innate associative capabilities of people are relied for this type of puzzle. It may be quite difficult for a computer to answer qualitative questions, such as deciding what is good and bad or right and wrong. Of course people may not always agree on the answers to such questions. Although people may provide differing answers, tracking all of the answers in a community database as previously described can enable analysis to determine a set of valid answers based on community feedback. In this example, possible valid answers may include “Clock”, “3 and 6”, “6 and 3” to name a few.

Another example image-based puzzle 702 asks a series of questions regarding an image having several objects. In particular, the objects include an automobile, a pencil, a cup of coffee, a computer, and the Earth. In this puzzle, the user is asked to answer a set of nuanced questions regarding the size of the objects in different contexts. An image-based puzzle can be configured to ask one or more such questions regarding a set of objects. It may again be quite difficult for a computer to answer these nuanced questions. Careful selection of the images and questions to make use of innate human capabilities can result in powerful image-based puzzles.

Image-based puzzle 704 provides an example in which an image of a Christmas tree is depicted and an associated answer prompt asks “What is missing from this image?” Once again, it may be difficult for a computer system to determine when something is absent from an image. Often this task is quite simple for people. Accordingly, the human experience and qualitative analysis involved in deriving a suitable answer to such a puzzle can be leveraged to craft a successful image-based puzzle. As noted, collection of data on the backend in a HIP database can inform a determination of which puzzles and corresponding answers successfully distinguish between human input and non-human input.

Note that a given image-based puzzle may have multiple valid answers. Any answer suitable to distinguish between humans and computers can be considered valid. For the image-puzzle 704, one user may input an answer of “Star”. Other user answers may include “Santa” and “Presents”. So long as the image-based puzzle is configured such that a computer would not or would be unlikely to derive these answers, then each of the answers can be valid.

### Conclusion

Embodiments to enable image-based human interactive proofs have been described herein. Although the subject matter has been described in language specific to structural features and/or methodological steps, it is to be understood that the subject matter defined in the appended claims is not necessarily limited to the specific features or steps described. Rather, the specific features and steps are disclosed as example forms of implementing the claimed subject matter.

What is claimed is:

1. A computer-implemented method comprising:
providing to a client one or more graphical images that form an image-based puzzle, wherein the one or more graphical images do not contain text sufficient to derive a valid answer to the image-based puzzle;
receiving input regarding the one or more graphical images from the client; and
determining whether the input regarding the one or more graphical images is human input or non-human input.

2. A computer-implemented method as recited in claim 1, wherein the input is provided as an answer to the image-based puzzle.

3. A computer-implemented method as recited in claim 1, further comprising selectively enabling the client to access one or more resources via a web server based upon the determining.

4. A computer-implemented method as recited in claim 1, wherein the providing comprises outputting a user interface having the one or more graphical images and operable by the client to provide the input.

5. A computer-implemented method as recited in claim 1, further comprising enabling the client to access one or more resources from a web provider when the input is determined to be human input.

6. A computer-implemented method as recited in claim 1, wherein at least one of the one or more graphical images is obfuscated to prevent recognition of the image by a computer.

7. A computer-implemented method as recited in claim 1, wherein the received input is to answer the image-based puzzle by matching the one or more graphical images to one or more descriptions.

8. A computer-implemented method as recited in claim 1, further comprising enabling the client to access one or more resources available via a web server when the received input describes a commonality of the one or more graphical images that is capable of being perceived by a human.

9. A computer-implemented method as recited in claim 1, wherein determining whether the input is human input or non-human input comprises comparing the input to one or more descriptions of the one or more graphical images, the one or more descriptions known to be from humans.

10. A computer-implemented method comprising:
comparing input received from a client regarding an image-based puzzle to known input from one or more humans regarding the image-based puzzle;
determining whether the input received from the client is human input or non-human input based on the comparing;
if the input is human input, enabling the client to access one or more resources; and
if the input is non-human input, denying the client access to the one or more resources.

11. The computer-implemented method of claim 10, further comprising:
communicating the image-based puzzle over a network to the client responsive to a request from the client to access the one or more resources; and
receiving the input regarding the image-based puzzle from the client over the network.

12. The computer-implemented method of claim 10, wherein the input is a description of a commonality shared by a plurality of images in the image-based puzzle.

13. The computer-implemented method of claim 10, wherein the input is to match a plurality of images in the image-based puzzle to one or more descriptions.

14. The computer-implemented method of claim 10, wherein the image-based puzzle includes a textual description and the input comprises a selection of an image in the image-based puzzle as a best match to the textual description.

15. The computer-implemented method of claim 10, wherein the image-based puzzle includes one or more images that have been obfuscated to prevent recognition of the images by a computer.

16. The computer-implemented method of claim 10, wherein the one or more resources include functionality to enable the client to establish a user account with a web provider.

17. The computer-implemented method of claim 10, wherein the one or more resources include a web service available over a network from a web provider.

18. A system comprising:
one or more computer-readable storage media; and
computer-readable instructions embodied on the one or more computer-readable storage media which, when executed, implement a human interactive proof (HIP) management module configured to:
provide an image-based puzzle to a client when the client seeks access to one or more resources;
receive an answer to the image-based puzzle input by the client;
determine whether the received answer is from a human; and
enable the client to access the one or more resources responsive to the received answer being determined to be from a human.

19. The system of claim 18, wherein the image-based puzzle comprises one or more graphical images.

20. The system of claim 18, wherein to determine whether the received answer is from a human comprises comparing the received answer to a collected answer regarding the image-based puzzle known to be from a human.
